(19) United States
(12) Patent Application Publication
(10) Pub. No.: US 2013/0321145 A1
(43) Pub. Date: Dec. 5, 2013

(54) TRACPOINT™ RULES-BASED TELEMATICS PATIENT CARE LOCATION SYSTEM

(71) Applicants: Ronald Ranieri, Smithtown, NY (US); Robert Heppenheimer, Northport, NY (US)

(72) Inventors: Ronald Ranieri, Smithtown, NY (US); Robert Heppenheimer, Northport, NY (US)

(21) Appl. No.: 13/487,276

(22) Filed: Jun. 4, 2012

(51) Int. Cl. G08B 1/08

(52) U.S. Cl. 340/539.12

(57) ABSTRACT

A rules engine based telematics patient care locationing system called TracPoint™, for use in hospitals and healthcare congregate residency locations. The specific telematics e-health patient care software utilizes a rule based logic that combines RFID locationing information with preset location, time or relationship based rules (or combinations thereof) to monitor and automatically notify caregivers upon the violation of one or more specific or general rules. A rules engine applies selected rules stored in the data base to individual tags worn by people or applied to objects, to produce an output based on the individualized rule set for that specific tag, triggering a notification sequence that can include preprogrammed notifications via email, text or audible alerts when the specific parameters of the applied rule is violated. The tracking of the rules is in real time against the second by second location data provided by the RFID readers located throughout an area.

### FIELD OF THE INVENTION

The present invention and its preferred embodiments relates to an e-Health, telematics classification of e-health patient care monitoring systems in general, but more specifically to a congregate facility resident-patient environment and critical assets monitoring and maintenance system.

Healthcare IT spending is expected to reach $45 billion by the end of 2012, according to a study from market research firm RNCOS.

Much of that growth will come from spending on electronic health record (EHR) systems, mobile health applications, resident patient e-health care, and efforts to comply with new government standards.

Boosted by increased spending on healthcare software—which is needed for the rollout of EHR systems and resident patient e-health care—the U.S. healthcare IT market is expected to grow at a rate of about 24% annually from 2012 to 2014, the study said. Spending on healthcare software rose 20.5% in the past year, from $6.8 billion in 2010 to a projected $8.2 billion this year, according to RNCOS.

Recent mergers and acquisitions in the healthcare IT market also point to growing private-sector interest in software, which will see sales grow at rate of more than 30% annually from 2012 to 2014, the report said.

The study attributed some of the increase in spending to the Healthcare Reform Act, the new ICD-10 coding system, and adoption of EHR systems, which will be mandatory by 2015. Also a factor: Medicaid enrollment, which is expected to increase by 16 million people by 2019.

ICD-10 is a comprehensive medical coding system that includes more than 550,000 codes; hospitals are required to be using it by Oct. 1, 2013.

And the adoption of EHR technology—hastened by the requirement that healthcare facilities must achieve “meaningful use” of such systems—is forcing hospitals and other healthcare providers to move ahead with technology implementations faster than ever.

In addition, the RNCOS report noted that consumers are keenly interested in the benefits of mobile health technology. The mobile health market is estimated to hit $2.1 billion by the end of the year. It has grown by 17% in each of the past two years.

The main driver behind that double-digit growth rate is the increasing use of smartphones, GPS, and continuous wireless patient monitoring. By the end of 2011, 50% of mobile phones in the U.S. are expected to be smartphones, up from 21% in 2009.

As a result, according to market research firm Research2guidance, healthcare-related smartphone apps are set to become hugely popular. The research firm projects that some 500 million people will be using such apps within five years.

According to the Global Mobile Health Market Report 2010-2015 compiled by Research2guidance, more than one-third of 1.4 billion smartphone users in 2015 will be running some kind of mobile healthcare app.

A recent online survey sponsored by the wireless industry association CTIA found a similar level of interest in health-oriented apps. In the CTIA survey, 78% of respondents said that they were interested in mobile health products and services and 15% said that they were extremely interested in learning more. “This signifies that the awareness among the consumers regarding [mobile health] services is increasing, which has played an important role in the growth of the market,” the RNCOS report said.

More than 72% of physicians in the U.S. are now smartphone users, according to the RNCOS report. And tablet devices are also catching on in the medical community: More than 20% of all U.S. physicians have iPads.

Healthcare apps for smartphones are one of the main reasons for this increased usage. There are already more than 10,000 mobile applications related to health, and about 40% of those are designed for healthcare professionals. That figure includes remote monitoring and healthcare management applications. Even Apple's iTunes store has about 6,000 mobile health apps.

As the mobile health market surges ahead, there is an emerging call within the medical community for a dedicated wireless spectrum for healthcare use. That spectrum would augment commercial mobile broadband networks, which have significant coverage gaps and face reliability issues.

Earlier this year, healthcare providers and the aeronautics industry association urged the Federal Communications Commission (FCC) to approve a mobile body area network (MBAN) plan. The MBAN radio spectrum would create a wireless body sensor network for remotely monitoring critically and chronically ill people via small wireless devices. That would allow caregivers to track a person's health status and take swift action in any emergencies.

The American Telemedicine Association also has asked the FCC to consider setting aside small portions of spectrum for the exclusive use of healthcare professionals. No decision on the spectrum requests has yet been made.

### BACKGROUND OF THE INVENTION

Embodiments of the present invention relate to a software rules engine controlled and monitored e-health telematics system called TracPoint™. TracPoint™ is a comprehensive solution, combining uniquely designed Resident Management Information Software with state of the art UWB (ultra wide band)/RTLS (real time location system) technology.

TracPoint™ enables a plurality of e-healthcare givers to assess the disparate needs of a plurality of individuals entrusted in an e-healthcare giver's care and determines the specific range of that resident's independence. Key features for utilizing wireless TracPoint™ are:
Locate and monitor e-healthcare residents in real time by battery-less and wireless method means.
Enhance the development and management of individualized e-health resident's safety care plans by battery-less and wireless method means.
Request immediate assistance with response button (tag) by battery-less and wireless method means.
Tag critical assets for easy location and monitor their preventative maintenance schedule by battery-less and wireless method means.
Record & archive historical location data for playback purposes by software security and care rules engine method means.

Prior art in hospitals, nursing homes, or congregate facilities have long struggled with problems related to resident-patient wandering and elopement. This is further compounded in a hospital or congregate facility e-healthcare resident-patient environment. Behavior management and e-healthcare resident-patient safety are two of the most essential requirements of Federal and State licensing agencies and regulations on all long term care providers. If a resident-patient leaves a facility un-noticed by staff, said e-healthcare resident-patient is at high risk of imminent danger of personal harm possibly ending in loss of life. In addition to the severe ramifications on a Facility from a liability and public relations perspective, the facility is also subject to potentially crippling, regulatory sanctions and reimbursement fines. This prior art concept also extends to current care systems of prior art in addition to a common scenario of a e-healthcare resident-patient wearing a passive RFID device approaches a door or elevator which then sets off a loud audible alarm for staff to respond. The alarm sound, alarm radius and sensitivity are fixed for all e-healthcare residents regardless of their individual behavior or needs. The system is fixed to ring an alarm and/or lock a door only when approached with no tracking or monitoring capability, and no ability for the facility to adjust the system for a specified e-healthcare resident-patient and their specific needs. They are useless for any other purpose other than their limited range and function.

It is a goal of said present invention to allow for and enable interminable, non-compromising and unrestricted safety and mobility of said hospital or congregate facility resident-patient in a hospital or congregate environs without any lapse or compromising of safety or care of said hospital or congregate facility resident-patient. This novelty of said present invention is put into practice with interminable communication coordination amongst an on-site caregiver or a plurality of on-site caregivers so defined as on-site in all locations within said internal and said external designated perimeter mesh zones; and a designated remote guardian on-site caregiver or a plurality of designated remote guardian on-site caregivers; and a on-site central computer portal method means with high speed internet access; and a remote administrator computer portal with high speed internet access.

It is another goal of said present invention to provide said hospital or congregate facility resident-patient with a non-compromising wristband method means, but not limited to just a wristband method means in combination with said attached RF wireless tag method means that is in interminable communication with said RF wireless reader method means all effectively communicating with all said readers in all said designated safe perimeter mesh zones.

It is another goal of said present invention to provide a wristband method means with embedded wire trigger method means to be the alert means for annunciating any attempted severing of said wristband method means by said patient, but not limited to said patient; and said severing attempt being carried out by any intruder or safety compromising personage or plurality of said safety compromising personage, not in the category of said on-site caregiver or plurality of on-site caregivers.

It is another goal of said present invention to provide an RF wireless reader method means or plurality of RF wireless reader method means that are in interminable communications with all other RF wireless reader method means and all other RF wireless tag method means, with purpose of providing said interminable and non-compromising care to said hospital or congregate facility resident-patients or plurality of said hospital or congregate facility resident-patients.

It is another goal of said present invention to have uncompromising and interminable awareness of said on-site caregiver or a plurality of said on-site caregiver personage location within said internal and said external designated perimeter mesh zones.

Another goal of said present invention is to provide within said internal and said external designated perimeter mesh zones an infra-red wireless transceiver method means that provides interminable motion interrogation of said hospital or congregate facility resident-patient's movement throughout said mesh zones.

Another goal of said present invention to incorporate within said wrist band tag method means, an accelerometer motion detector method means that is in interminable communications through electrical connexion to said RF wireless wearer's tag transmitter method means that is in interminable communication with a designated high speed internet access in interminable communication with said remote administrative computer portal method means. Where said accelerometer motion detector method means emits and propagates effectively, a burst ping alert signal periodically and interminably; and where said alert signal's periodicity is optimized for the longest amount of emitted ping signal per unit time so adjusted to provide the maximum battery lifetime of said wrist tag method means operation.

It is a goal of said present invention embodiments to enable said GPS RF wireless transceiver method means to take control once a hospital or congregate facility resident-patient is out of range of said designated safe perimeter mesh zones; and annunciate said location of said a hospital or congregate facility resident-patient or a plurality of a hospital or congregate facility resident-patients periodically so that constant updating of said location under question will be received by said on-site caregiver or plurality of said on-site caregivers and said remote administrator computer portal by way of high speed internet access. Where said GPS RF wireless transceiver method means interminably emits and propagates effectively, a burst ping alert signal periodically and interminably; and where said alert signal's periodicity is optimized for the longest amount of emitted ping signal per unit time so adjusted to provide said maximum battery lifetime of said wearer's tag method means operation.

Further goal of said present invention is the interminable monitoring of said on-site caregiver and if for any reason said on-site caregiver leaves said hospital or congregate facility resident-patient designated perimeter mesh zones without notice; or failure to announce a report-in absence validation voucher, said internet accessed administration portal is alerted and said on-site caregiver, or plurality of said on-site caregiver personage is signaled if failure to summon said on-site caregiver arises. In addition said GPS wireless transceiver method means embedded in said on-site caregiver RF wireless transceiver tag method means monitors and communicates said movement of said absent on-site caregiver when out of range of all said designated mesh zones.

Another embodiment and intention of said present invention is to utilize a patented DEAK™ battery-less and wireless transceiver method means, but not limited to a battery-less and wireless transceiver method means for further enhancing and validating the concept of a feasible interminable, non-compromising and unrestricted safety and mobility of said hospital or congregate facility resident-patient in a hospital or congregate environs without any lapse or compromising of safety or care of said hospital or congregate facility resident-patient.

Another embodiment and intention of said present invention is to utilize a patented DEAK™ battery-less and wireless transceiver method means, but not limited to a battery-less and wireless transceiver method means for further enhancing and validating the concept of a feasible interminable, non-compromising and unrestricted assets security and location monitoring.

Another embodiment and intention of said present invention is to utilize a patented DEAK™ battery-less and wireless transceiver method means, but not limited to a battery-less and wireless transceiver method means for further enhancing and validating the concept of a feasible interminable, non-compromising and unrestricted on-site resident patient monitoring method means.

Another embodiment and intention of said present invention is to utilize a patented DEAK™ battery-less and wireless transceiver method means, but not limited to a battery-less and wireless transceiver and DEAK™ battery-less power source method means for further enhancing and validating the concept of a feasible interminable, non-compromising and unrestricted on-site resident patient motion detection method means.

Another embodiment and intention of said present invention is to utilize a patented DEAK™ battery-less power source method means for further enhancing and validating the concept of a feasible interminable, non-compromising and unrestricted on-site resident patient motion detection method means.

Another embodiment and intention of said present invention is to utilize a patented DEAK™ battery-less power source method means for further enhancing and validating the concept of a feasible interminable, non-compromising and unrestricted on-site resident non-patient assets security detection and tracking method means.

### SUMMARY OF THE INVENTION

### TracPoint™ Rules Based System

TracPoint™ is a rule based patient care locationing system for use in healthcare and or residential locations. The software utilizes a rule based logic that combines RFID locationing information with preset location, time or relationship based rules (or combinations thereof) to monitor and automatically notify caregivers upon the violation of one or more specific or general rules. Said rules engine applies selected rules stored in the data base to individual tags worn by people or applied to objects, to produce an output based on the individualized rule set for that specific tag, triggering a notification sequence that can include preprogrammed notifications via email, text or audible alerts when the specific parameters of the applied rule is violated. The tracking of said rules is in real time against the second by second location data provided by the RFID reader device means located throughout an area.

For example:

Time Based Rule

Send an alert if a patient does or does not leave their room within a set time frame.

Rules can change based on time of day.

Location Based Rules

Send an alert if a patient tries to use an exit area at any time.

Send an alert if a resident gets within 5/10/15 feet of an exit.

Send an alert if a resident enters an unsafe area (kitchen, stairway, exit door);

said unsafe areas are programmed into said rules engine.

Relational Based Rules

Send an alert if a resident gets within a specified distance of another resident.

Send an alert if a resident is not associated with said other resident (within 3 or less feet) or a piece of equipment (i.e. wheelchair, IV pole).

Send an alert if 2 tags get within a specified range of another tag device means.

The TracPoint™ software compares said rule set for each resident against the second by second location data for the specified tag device means and triggers various alerts when a rule is violated.

Said rules are both positive and negative—if a tag device means enters a zone it will activate a rule versus a resident not being in the zone will also trigger a rule.

Resident A: Dementia, Wandering

Rule Sets:
1. Between 7 pm and 8 AM alert staff if resident leaves their room.
2. Between 8 AM and 2 pm alert staff if resident comes within 5 feet of a door.
3. Between 2 pm and 7 pm alert staff if resident comes within 20 feet of an exit door.
4. At all times, notify staff if they (patients) enter any other resident room.

Resident B: Self Isolates, Fights with Resident C
1. Track resident movement and create a report when resident leaves room, for how long and to where.
2. If resident B comes within 25 feet of resident C, alert staff to prevent altercation.
3. Between 7 pm and 8 AM alert staff if resident leaves their room.
4. Notify staff if resident remains in room for more than 4 hours.

Resident C: Alert, Short Term Patient
1. Resident is scheduled for PT (physical training) at 9 am. Notify staff if resident is not in rehab room at 9 AM.
2. Resident has mobile call bell and will trigger as needed.
3. Resident is in specialized wheelchair—notify staff if resident is not associated with their own wheelchair between 8 AM and 7 pm.

Equipment TAG—on a Rented Concentrator Attached Asset
Notify staff when rental is scheduled to end.
Notify vendor when rental is completed.
Notify staff if rented concentrator attached asset is moved into/out of a location.
Tracking, monitoring—compares to rules set for time, distance or relation to other tags

In accord with the preferred embodiments and goal of said present invention; there is provided and maintained a designated mesh zone means, patient medical monitoring means, assets security location monitoring, and communications system method means capable of interminable and non-compromising hospital, nursing home, or congregate facility resident-patient care; based upon said preferred embodiments that are a composite patient care and security software rules engine that commands all activities and establishes any and all rule changes and system variations that can be initiated and altered by an authorized administrator rules command control method means, for any purpose that secures and guarantees a feasible interminable, non-compromising and unrestricted system method means of patient care, safety, and protection.

It is a further intention of said invention to provide a general monitoring care system means that can be applied without restriction to any type of patient care or living being care, such as animals in confined places of interest and environs; or inanimate objects in confined and private or public places of interest and environs.

It is an intention of said present invention to provide by a computer system means or a plurality of computer systems means with high speed internet access and communications means; interminable and uninterrupted hospital, nursing home, or congregate facility resident-patient monitoring or a plurality of home or congregate facility resident-patients monitoring; executed by wearable hospital, nursing home, or congregate facility resident-patient identification tag means, which through RF wireless device means and IR (infra-red) wireless device means; transmit and communicate within vicinity of said hospital, nursing home, or congregate facility resident-patient on site caregivers, remote from said hospital, nursing home, or congregate facility resident-patient on site caregivers, and computer system with high speed internet access and communications means administration portals.

It is another intention of said present invention to calculate and report said hospital, nursing home, or congregate facility resident-patient or a plurality of said hospital, nursing home, or congregate facility resident-patients movement and all kinetic activity within the perimeter of all designated interior and exterior approved and validated location and environment definitions.

It is another intention of said present invention to enable adequate unrestricted hospital, nursing home, or congregate facility resident-patient mobility without any harm to said home or congregate facility resident-patient or plurality of home or congregate facility resident-patients.

It is another intention of said present invention to monitor and report on site caregiver location information by RF wireless means.

It is another intention of said present invention to monitor and report on site caregiver location information by IR (infra-red) wireless means.

It is another intention of said present invention to prevent said hospital, nursing home, or congregate facility resident-patient or a plurality of said home or congregate facility resident-patients from diverting away from all designated safe perimeter mesh zones by wearing a non-compromised wireless wristband tag means that has GPS transceiver capabilities and a transceiver means to report an instant location of said hospital, nursing home, or congregate facility resident-patient or a plurality of said hospital, nursing home, or congregate facility resident-patients.

It is another intention of said present invention to insure said hospital, nursing home, or congregate facility resident-patient or plurality of said patients from removing said RF wireless wristband tag means by said novelty of an embedded wire means in said strap band of said RF wireless wristband tag device means. In order to remove said wristband and tag, any personage must sever and consequently cut and break the circuitous continuity of said embedded wire means.

It is another intention of said present invention for said rules engine to monitor and maintain secured, all portals of egress germane to all said internal and said external designated safe perimeter mesh zones for safe hospital, nursing home, or congregate facility resident-patient mobility within said safe designated perimeter mesh zones.

It is another intention of said present invention to, by action of its said rules engine teaching and design, to assign and validate all designation of said non-compromising with interminable wireless transmission reporting hospital, nursing home, or congregate facility resident-patient and on site caregiver location system with all affinitive on site caregivers, all affinitive remote guardian on site caregivers, affinitive on-site high speed internet access computer portal, and said affinitive administrative high speed internet access computer portal.

It is another intention of said present invention for said rules engine to teach that said custom software rules engine development means is unique and effective to orchestrate aggregate of said present contiguous system component means and aggregate personage with said on-site high speed internet access computer portal means and said administrative high speed internet access computer portal means, to insure non-compromised safety and care of said hospital, nursing home, or congregate facility resident-patient or ward or said plurality of patents or wards.

Further it is another intention of said present invention rules engine that by using a GPS satellite transceiver device means in interminable and non-compromising communications with said hospital, nursing home, or congregate resident-patient's wearable wristband RF transceiver tag device means, said hospital, nursing home, or congregate resident-patient or a plurality of said hospital, nursing home, or congregate resident-patients are monitored for their instant location, safety, and caregiving. Through the obvious means offered and executed by said present invention and it should be obvious to anyone steeped in the art that these means are carried out in said manner.

Another embodiment and intention of said present invention is to utilize a patent pending or patented DEAK™ battery-less and wireless transceiver device means, but not limited to a battery-less and wireless transceiver device means for further enhancing and validating the concept of a feasible interminable, non-compromising and unrestricted safety and mobility of said hospital or congregate facility resident-patient in a hospital or congregate environs without any lapse or compromising of safety or care of said hospital or congregate facility resident-patient.

One of the major common problems with prior art is that their wireless tags or communications links are powered by batteries to establish portability and mobility, which remains as a potential maintenance problem and constraint. To overcome this critical problem and maintenance constraint, by its preferred embodiments, it is the intention of said TracPoint™ system to teach that any battery related power loss problem will be eliminated by utilizing a battery-less and wireless transceiver tag device method means like that of the patent pending or patented DEAK™ battery-less and wireless transceiver device method means to establish a battery-free continuous powered operation; thus ensuring improved performance and a feasible interminable, non-compromising and unrestricted operation over that of prior art.

Another embodiment and intention of said present invention is to utilize a patent pending or patented DEAK™ battery-less and wireless transceiver device method means, but not limited to a battery-less and wireless transceiver device method means for further enhancing and validating the concept of a feasible interminable, non-compromising and unrestricted assets security and location monitoring.

Another embodiment and intention of said present invention is to utilize a patent pending or patented DEAK™ battery-less and wireless transceiver device method means, but not limited to a battery-less and wireless transceiver device method means for further enhancing and validating the concept of a feasible interminable, non-compromising and unrestricted on-site resident patient monitoring method means.

Another embodiment and intention of said present invention is to utilize a patent pending or patented DEAK™ battery-less and wireless transceiver device method means, but not limited to a battery-less and wireless transceiver and a patent pending or patented DEAK™ battery-less power source device method means for further enhancing and validating the concept of a feasible interminable, non-compromising and unrestricted on-site resident patient motion detection method means.

Another embodiment and intention of said present invention is to utilize a patent pending or patented DEAK™ battery-less power source device method means for further enhancing and validating the concept of a feasible interminable, non-compromising and unrestricted on-site resident patient motion detection method means.

Another embodiment and intention of said present invention is to utilize a patent pending or patented DEAK™ battery-less power source device method means for further enhancing and validating the concept of a feasible interminable, non-compromising and unrestricted on-site resident non-patient assets security detection and tracking method means.

With said present invention there are actions of said rules engine that can be programmed for a variety of possibilities for accommodating any hospital, healthcare facility that caters to a large or small congregate community and design program criteria are changed to meet different healthcare facility situations that can easily be programmed and updated by any administrator of designated member of staff. Further said TracPoint™ invention can be easily expanded or contracted to meet ever changing healthcare patient population, assets volume, building expansion, internet access vendors, and GPS vendors.

### BRIEF DESCRIPTION OF THE DRAWINGS

FIG. 1 is an overview graphic illustration diagram of the TracPoint™ e-healthcare telematics patient tracking and monitoring system.

FIG. 1A is a graphic illustration of the various rule sets for possible patient situations requiring immediate attention by administrators and staff members of a hospital or healthcare facility.

FIG. 1B is a graphic illustration of a computer video monitor scene of the TracPoint™ rules engine software within a windowed environment showing the menu bar and typical floor plan with animated activity of patients and staff.

FIG. 1C is a functional block diagram of the TracPoint™ Real Time Operating System.

FIG. 2 is a block diagram of the TracPoint™ battery-less and wireless ISM Band transceiver device that can be of a wrist band or pendant design for patients, staff, and assets monitoring.

FIG. 3 is a flow chart of TracPoint™ patient and staff tag monitoring and maintenance logic procedures of said rules engine.

FIG. 4 is a flow chart of TracPoint™ non-reporting caregiver tag monitoring and maintenance logic procedures of said rules engine.

FIG. 5 is a flow chart of TracPoint™ non-reporting or missing assets tag monitoring and maintenance logic procedures of said rules engine.

FIG. 6 is a flow chart of TracPoint™ time based rules for patient tag monitoring and maintenance logic procedures of said rules engine.

FIG. 7 is a flow chart of TracPoint™ patient vicinity to an exit door, kitchen area, or stairway tag monitoring and maintenance logic procedures of said rules engine.

FIG. 8 is a flow chart of TracPoint™ patient time slot and vicinity to an exit door tag monitoring and maintenance logic procedures of said rules engine.

FIG. 9 is a flow chart of TracPoint™ patient vicinity to another patient and patient room check against a prescribed time slot for approval of location monitoring and maintenance logic procedures of said rules engine.

FIG. 10 is a flow chart of TracPoint™ patient and assigned patient wheelchair vicinity to physical training room and patient room check against a prescribed time slot for approval of location monitoring and maintenance logic procedures of said rules engine.

FIG. 11 is a flow chart of TracPoint™ rental assets to vendor tallying and contract time monitoring compliance method means.

FIG. 12 is a graphic illustration of a wrist band or pendant battery-less and wireless transceiver tag device means; showing the battery-less power generator source section and security trigger wire device means.

FIG. 13 is a graphic illustration of a wrist band battery-less and wireless transceiver wrist band or pendant tag device means; showing the battery-less generator section that triggers the transceiver into action by a finger flick of the rotating ball magnet.

FIG. 14 is an illustration of the two separate components of the battery-less power source section and the battery-less and wireless wrist band or pendant tag device means.

FIG. 15 is a flow chart of TracPoint™ GPS logic sequence with one ping for every 15 seconds to conserve system power.

### DETAILED DESCRIPTION OF THE PREFERRED EMBODIMENTS

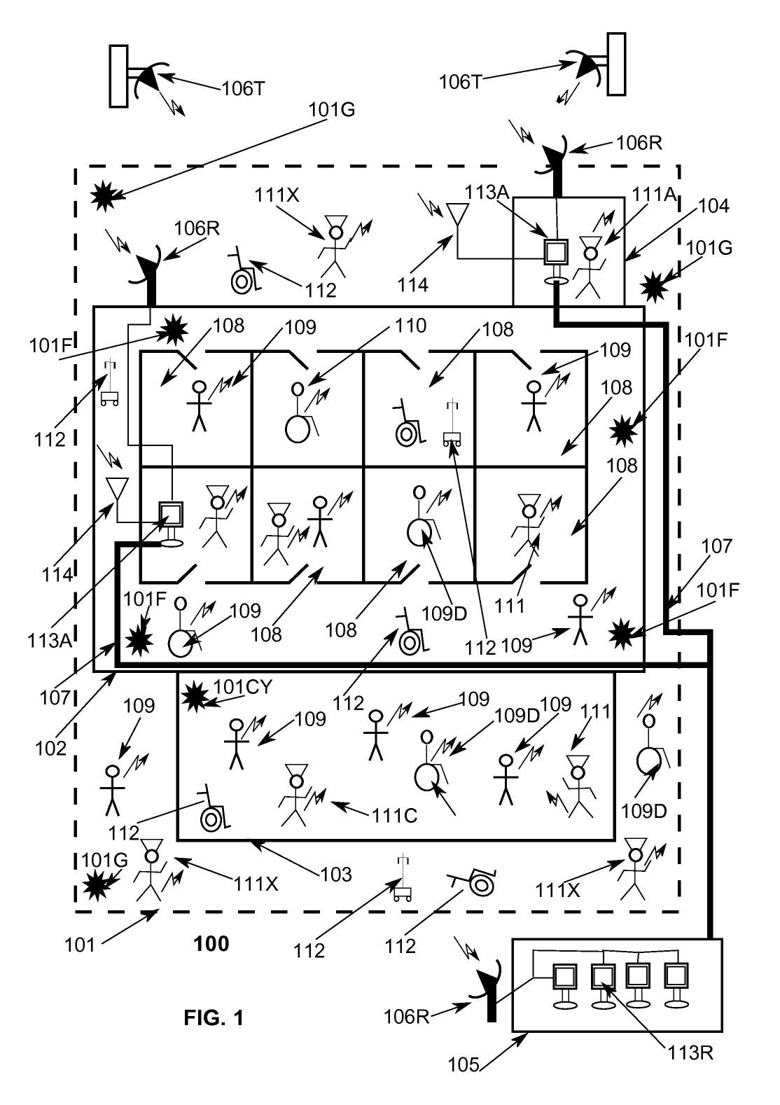

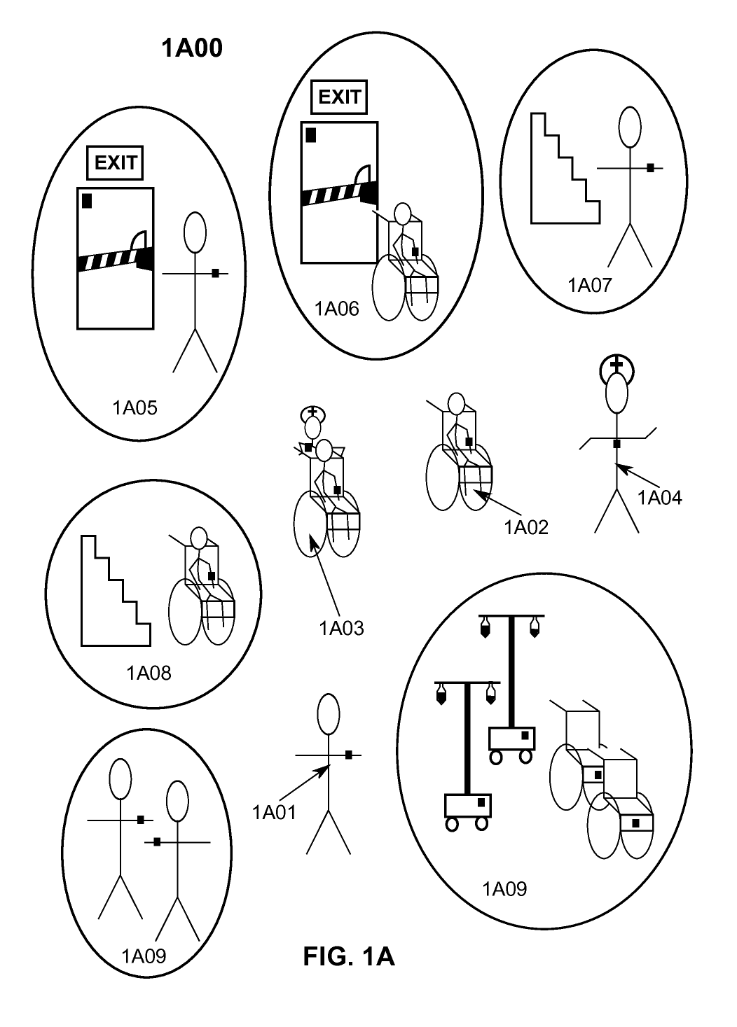

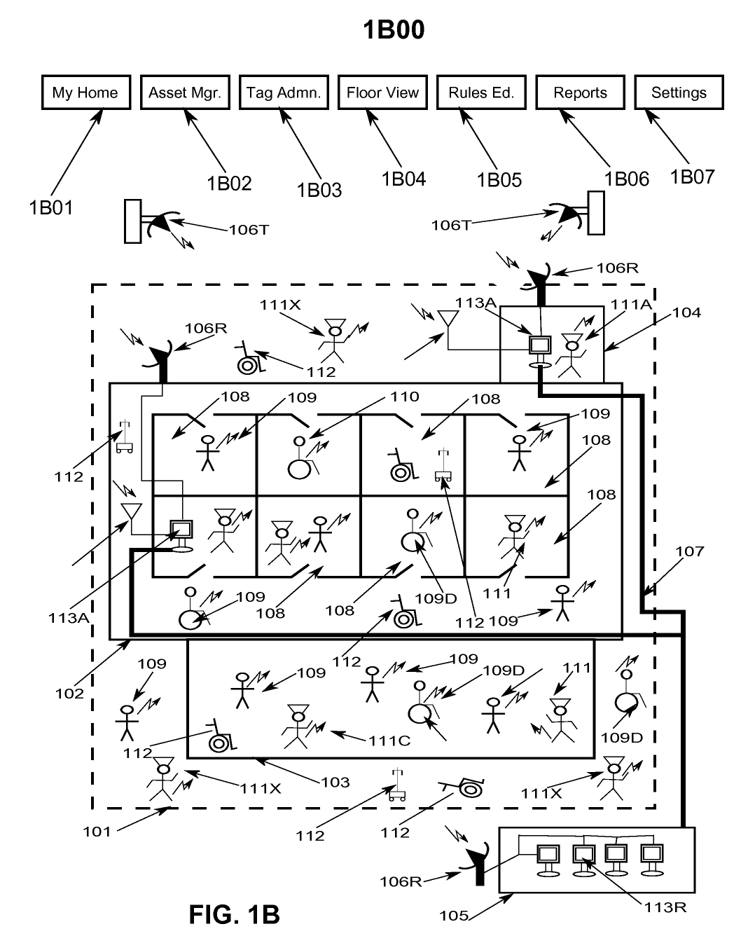

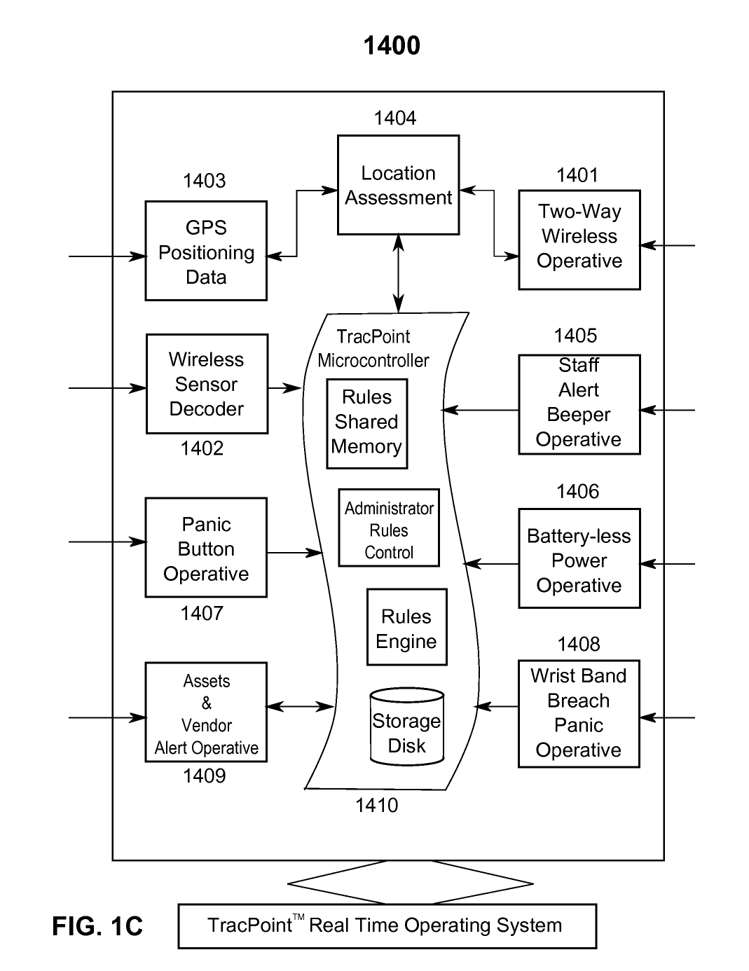

As stated in the afore described abstract of disclosure and shown in FIG. 1, said present invention is rule engine based telematics patient care locationing system 100 called TracPoint™, for use in hospitals and healthcare congregate residency locations.

The specific telematics e-health patient care software utilizes a rules engine based logic that combines RFID locationing information with preset location, time or relationship based rules (or combinations thereof), utilizing RFID reader repeaters device means 101F, 101CY, 101G with ranging to cover all of a facility interior 102, facility court yards 103 and associated grounds 101; to monitor and automatically notify caregivers upon the violation of one or more specific or general rules. A rules engine applies selected rules stored in the data base to individual tag device means worn by people or applied to objects, to produce an output based on the individualized rule set for that specific tag, triggering a notification sequence that can include preprogrammed notifications via email, text or audible alerts when the specific parameters of the applied rule is violated. The tracking of the rules is in real time against the second by second location data provided by the RFID reader repeaters device means 101F, 101CY, 101G located throughout an area that is further enhance by utilizing GPS tracking information 106T from a GPS receiver embedded with said patients 109, caregivers 111, or assets 112 tag device means. Said RFID reader repeaters device means 101F, 101CY, 101G are comprised of a device method means of decoding patient identity information and RF relaying said information back to a receiver in communication with a on-site facility central administrative computer that is by LAN (Local Area Network) 107 connected to a plurality of on-site daughter computers.

Said present TracPoint™ invention 100 is overviewed utilizing the graphics of FIG. 1 and the overall picture of patient healthcare; along with patient and asset location and security. A plurality of rules engine constraints, with times and location allowances are at the memory base of a plurality of facility computer system means 113A that are also in communication with said LAN 107 and a plurality of remotely located external computers 113R. Further, the TracPoint™ 100 system is in direct link to space GPS tracking systems 106T that sends distance, Ephemerides and Almanac data to said GPS facility receivers 106R and also to patient 109, caregiver staff 111, and asset 112 tags embedded each with a GPS receiver sub system and at said remote location 105 containing said plurality of remote computers 113R.

In FIG. 1A said set of rules engine examples 1A00 are shown as the instant location of any patient 1A01 mobile or stationary anywhere within the secured RF mesh covered area, the instant location of any patient confined to a wheelchair 1A02, mobile or stationary anywhere within the secured RF mesh covered area, the instant location of any patient confined to a wheelchair under the guidance of a caregiver 1A03 mobile or stationary anywhere within the secured RF mesh covered area, the instant location or absence of any caregiver staff member 1A04 mobile or stationary anywhere within the secured RF mesh covered area, the instant location any asset(s) 1A02 & 1A09 that are mobile or stationary anywhere within the secured RF mesh covered area, the condition where any patient mobile or stationary comes within said rules engine forbidden distance region of an exit door 1A05, the condition where any patient in a wheelchair mobile or stationary comes within said rules engine forbidden distance region of an exit door 1A06, the condition where any patient mobile or stationary comes within said rules engine forbidden distance region of a stairway 1A07, and the condition where any patient in a wheelchair mobile or stationary comes within said rules engine forbidden distance region of a stairway 1A08.

FIG. 1B shows an illustration of a typical on-screen computer monitor display 1B00 of the TracPoint™ rules engine based system. Said display screen 1B00 is visually comprised of menu window representation of the plurality of features custom to any specific facility patient/staff/asset population and facility physical size. Firstly, is displayed the plurality of pull down menus: A “My Home” menu 1B01, an “Asset Manager” menu 1B02, a “RFID Tag Administrator” control menu 1B03, A “Floor View” menu 1B04, A “Rules Editor” menu 1B05, A “Reports” menu 1B06, and a “Settings” menu 1B07. Then there is displayed the overall floor and grounds map view that is cursor selected at pull down menu Floor View 1B04 and a plurality of floors can be called up for display.

Ergo, during any given session of operation; an administrator or other staff member can select a plurality of situations and condition for setting up or changing a set of rules that are contained with said rules engine algorithms from said Rules Editor menu 1B05 and this is entered into said Reports menu 1B06 for healthcare records history. Said “My Home” menu 1B01 contains general submenu information regarding the software version, company, healthcare facility, administration IDs, staff members, patient lists, and assets ID and vendor information. Said “Assets Management” menu 1B02 contains specific submenu information on prescribed storage location, quantity of assets, maintenance and tracking information, and rental versus owned assets with rental vendor information. Said “Tag Administration” menu contains submenus of what patients ID, caregiver staff ID, and assets ID are along with location and time constraints and allowances that are programmed for; and this information is updated for records history in system memory. Said “Floor View” menu 1B04, contains submenus of any of a plurality of facility floor plans and sub-floor plans for viewing of patient, staff, and assets instant location and ID information with constraints, allowances, and prescribed slotted times for same. Said “Settings” menu 1B07, contains a plurality of submenus for adjusting and changing on-screen display formats, patient, staff, and assets graphic models and other miscellaneous items of floor plan colour, rooms, and general program features selections.

With FIG. 1C, a functional block diagram illustrates the working TracPoint™ Real Time Operating System (RTOS) 1400, which is best described as an algorithm rules engine with a microcontroller and device transmission and detection communications based LAN and GPS computer system means. The microcontroller 1410 contains Storage Disk for recording rules and updating any and all patient, staff and assets information, Rules Engine that contains sets of rules in software or firmware, Administrative Rules Control and Rules Shared Memory for making authorized updates and rules set system changes and detection device means such as patient, staff, and assets battery-less and wireless transceiver tags.

Gathering GPS Positioning Data 1403 is utilized for the location assessment means 1404 that determines instantly location information of patients, staff, and assets that are stored and updated by said TracPoint™ Microcontroller 1410.

Said Wireless Sensor Decoder means 1402 ID all tag wearers and exchanges information with said TracPoint™ Microcontroller 1410.

Further, said Panic Button Operative 1407 alerts all concerned through communication with TracPoint™ Microcontroller 1410.

Said Assets and Vendor Alert Operative 1409 is in communication with TracPoint™ Microcontroller 1410 relating to information of asset rental monitoring.

Said Two Way Wireless Operative 1401 is in two way communication with TracPoint™ Microcontroller 1410 for all tag wearers for ID, location, and compliance information.

Said Staff Alert Beep Operative 1405 ensures by its action to that alert emergency status signal is sent to all concerned tag wearing caregivers and administrators local and remote.

Said Battery-less Power Operative 1406 maintains constant quite mode device to computer communication information on status of said battery-less power source levels; and when a set minimum level exists an alert is given to administrator and staff to alleviate said situation by tag omni-directional movement to increase power levels. This can be done on a patient or asset by simple vibrational movement or can be applied remotely by a mechanical or electrical vibration sub-station. Usually patient and assets daily movement is sufficient for said battery-less power source to be full charged under a continuous electrical activity load condition.

Said Wrist Breach Panic Operative 1408 will send an alert to all tag wearers and administrators when a patient cuts or breaks a wrist band tag; and further said alert provides storage memory history information.

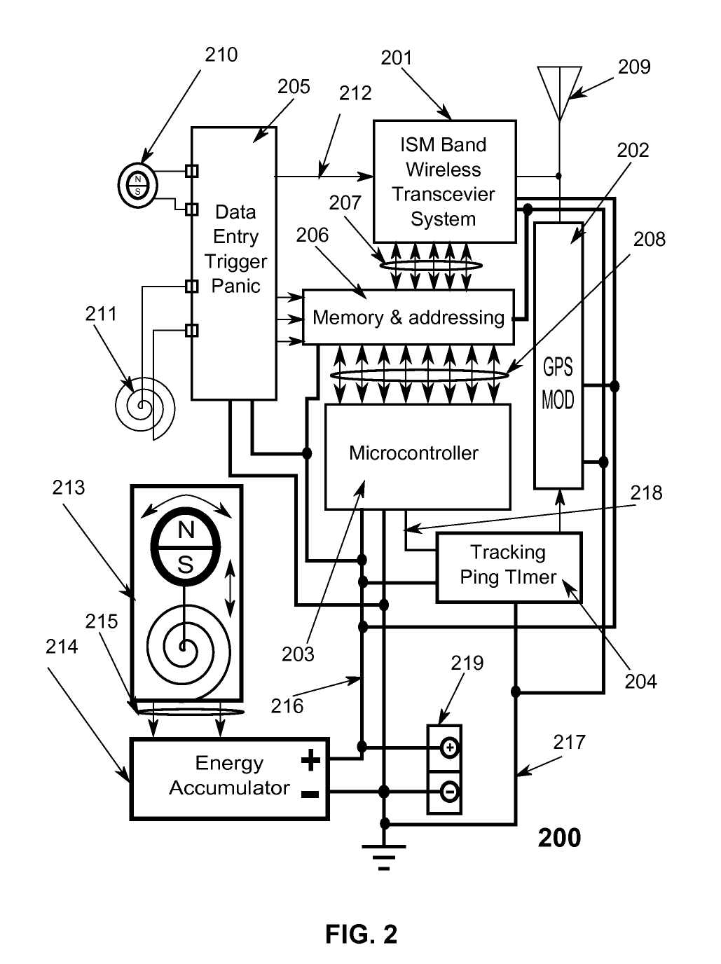

FIG. 2 is a functional block diagram of a battery-less and wireless tag device means 200 that is powered by a battery-less power source means 213 and tag triggering is executed by a battery-less trigger device means 210. There is an emergency alert thin wire loop 211 embedded within a wrist band so when a patient cuts said wrist band the wire breaks and sends an alert to staff. The output of data entry trigger module means 205 is in logic level communication with microcontroller 203. Memory and addressing of microcontroller algorithm for patient, staff, and assets ID is stored in memory 206 and data entry trigger module 205 is in communication by connexion 212 to ISM Band wireless transceiver module 201 that send and receives RF encoded data from multi-band long range antenna 209. GPS module 202 is also connected to say multi-band long range antenna 209. Battery-less power source 213 is connected to energy accumulator and rectifier 214 by connexions 215. Energy accumulator 214 provides DC power along power bus lines 216 & 217 for said ISM Band wireless transceiver 201 and GPS module 202. Also there is a terminal connection 217 in communication with said energy accumulator as a source of external backup by another auxiliary battery-less power source or even a lithium ion flat pack battery. Fifteen second duty cycle tracking ping time 204 is controlled by microcontroller 203 trigger pin 218 to turn on GPS module every fifteen seconds. Power bus positive connexion 216 and ground bus connexion 217 are routed throughout tag printed circuit area and connected to all utility modules.

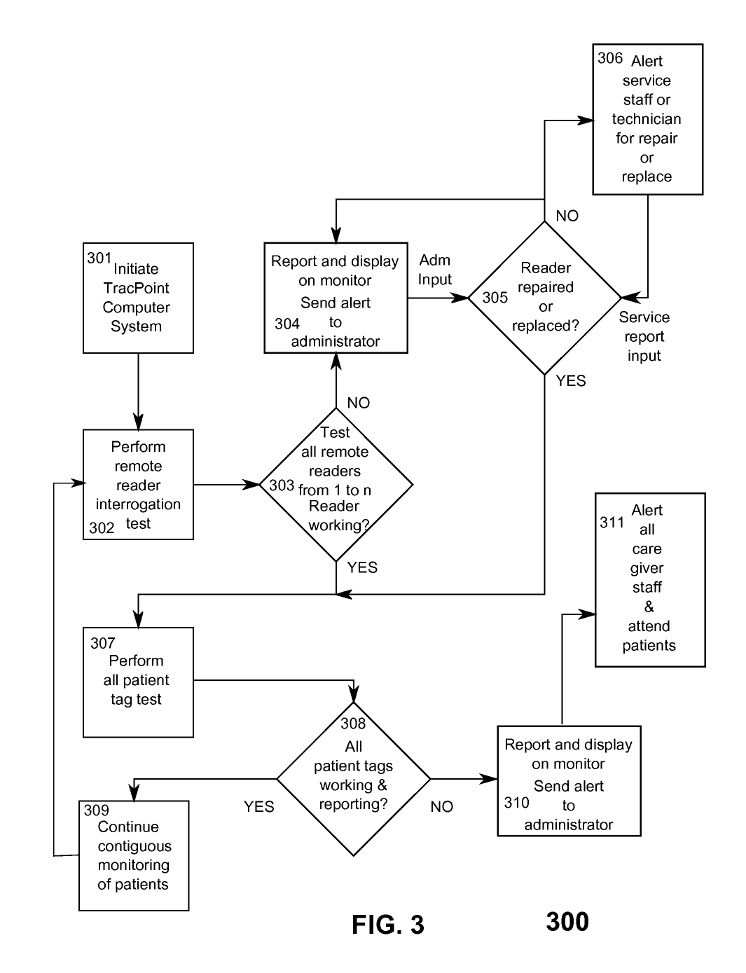

FIG. 3 is a logic flow chart for rules engine tag check sequence 300 that follows as: Initiate TracPoint™ 301 then perform remote reader interrogation test 302 test all remote readers from 1 to n 303 and if all are working YES, go to perform all patient tag test 307 are all patient tags working and reporting 308 if YES, continue monitoring patients 309 to loop back to initiate sequence at 301. At test all remote readers from 1 to n 303 if condition is NO, then report and display on monitor and send alert to administrator 304 and input administrator information to reader repair query 305, if repaired go to perform all patient tag test 307 if all patients tag are not working 308 go to report and display on monitor 304 and send alert to administrator 310 then alert all caregivers to attend patients 311. At logic reader repair query 305 if NO, then alert service staff for repair or replacement 306 then to service report input to repair or replace query decision 305.

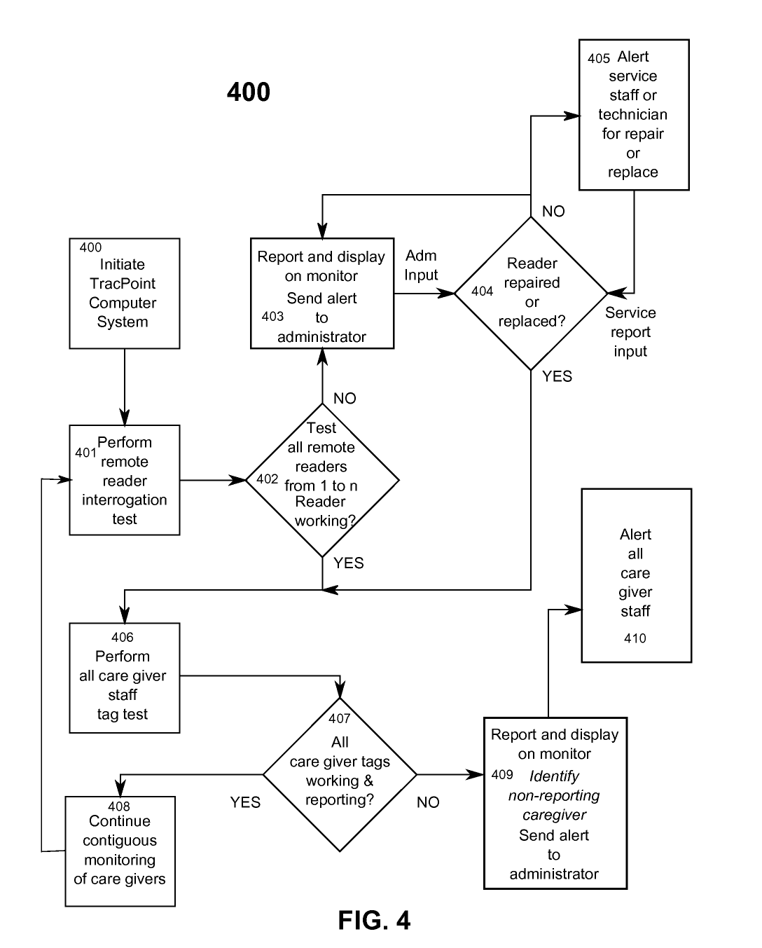

FIG. 4 is an exact duplicate logic flow chart 400 of rules engine tag check sequence 300, except it is for testing and interrogating all staff tag units. Same logic sequencing follows through.

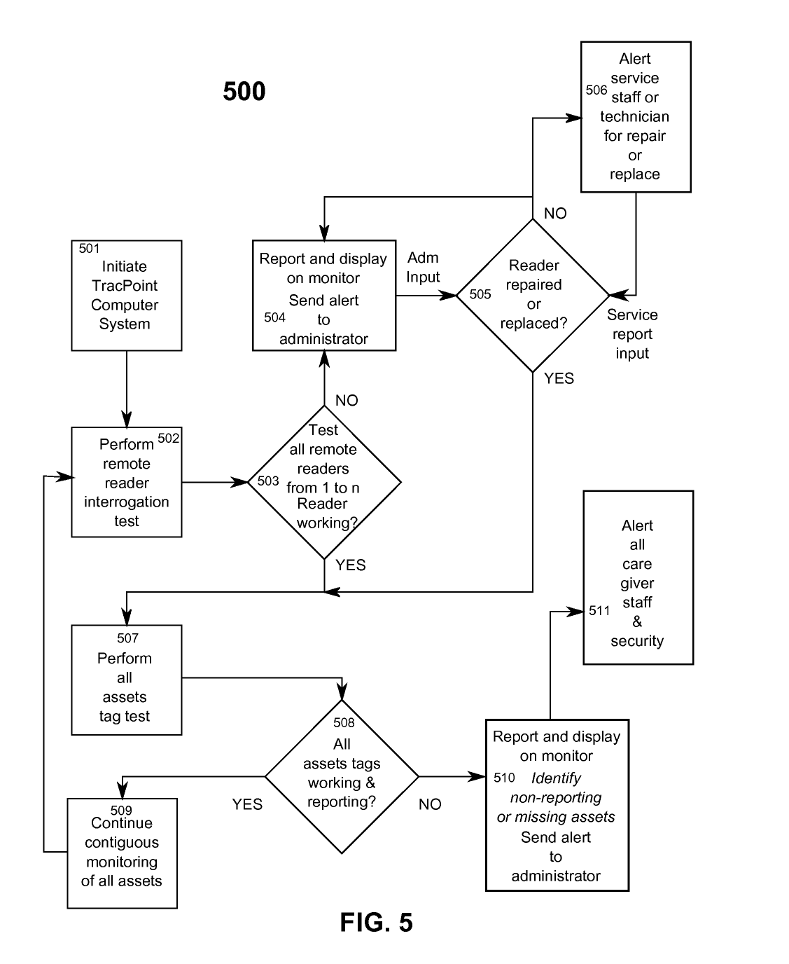

FIG. 5 is an exact duplicate logic flow chart 500 of rules engine tag check sequence 300 and 400, except it is for testing and interrogating all assets tag units. Same logic sequencing follows through.

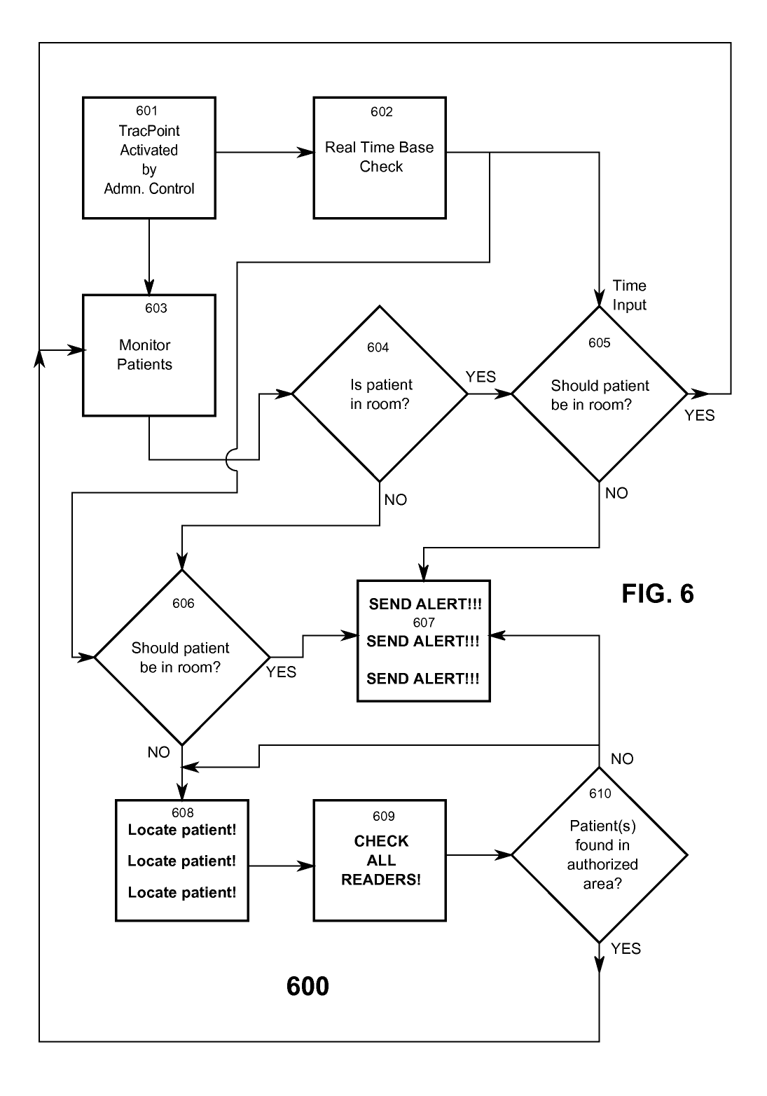

FIG. 6 is a logic flow chart depicting the logic flow through for determining whether patient(s) is in their designated room(s) and whether they should be in said room(s). As this logic follows through; TracPoint™ is initiated for this task 601 and patients are monitored 603 against a real time clock check 602. At logic sequence point, monitor patient 603 a logic decision is whether patient is in room? 604 if YES then logic decision of should patient be in room (?) against a real time clock is queried if YES, then go to patient monitoring 603. If NO, then send ALERT 607. At logic query is patient in room 604 if NO, then go to logic decision should patient be in room 606 if YES then send ALERT 607. At logic sequence point, should patient be in room if NO, then go to locate patient 608 then check all readers 609 then go to logic decision sequence point patients(s) found in authorized area 610 if YES, go to monitor patients sequence point 603. If NO, go to alert sequence point 607 and go to locate patient sequence point 608.

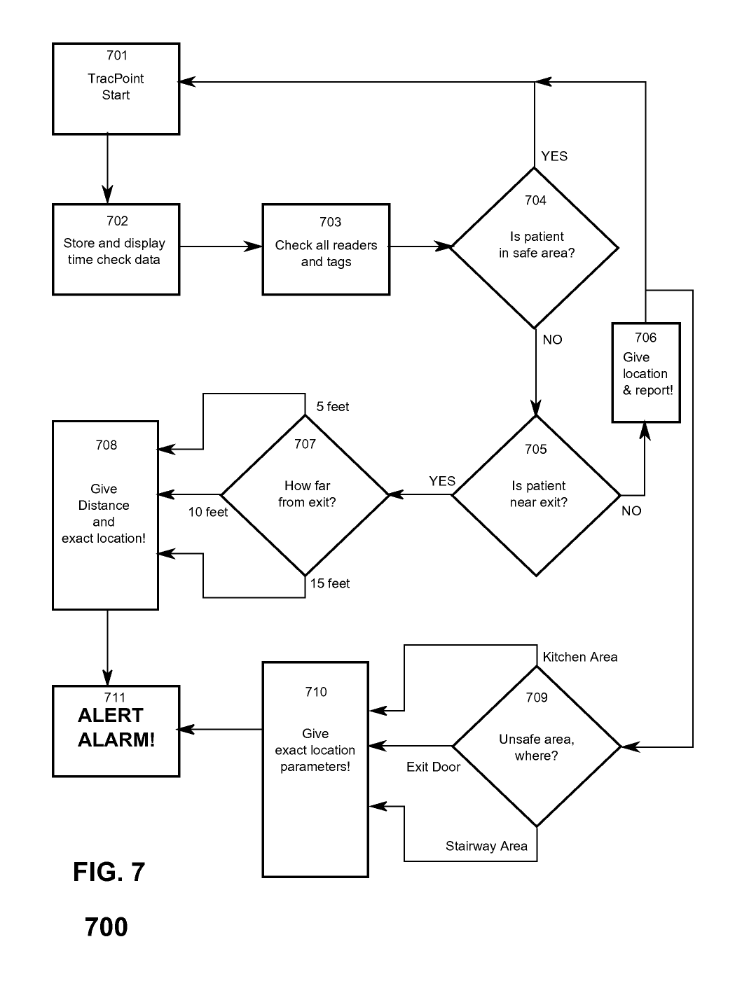

FIG. 7 is a logic flow chart sequence 700 depicting the logic flow through for when, where and how close a patient is to an exit door; whereby TracPoint™ task start 701 is executed then real time check data 702 is stored and the next logic sequence is for a check all readers and tags 703 then go to logic decision is patient in safe area (?) 704 and if YES go back to start 701 and if NO go to logic decision sequence point is patient near exit (?) 705. If query is YES go to decision sequence point how far from exit (?) 707; if 15 feet from exit give distance and exact location 708 then go to ALERT ALARM! 711; if 10 feet from exit give distance and exact location 708 then go to ALERT ALARM! 711; if 5 feet from exit give distance and exact location 708 then go to ALERT ALARM! 711. If patient is not near exit door 705 then go to give location and report 706 go back to start and also go to decision sequence point unsafe area where (?) 709; if in kitchen area go to give exact location parameters 710 then sound ALERT ALARM! 711; if in exit door area go to give exact location parameters 710 then sound ALERT ALARM! 711; if in stairway area go to give exact location parameters 710 then sound ALERT ALARM! 711.

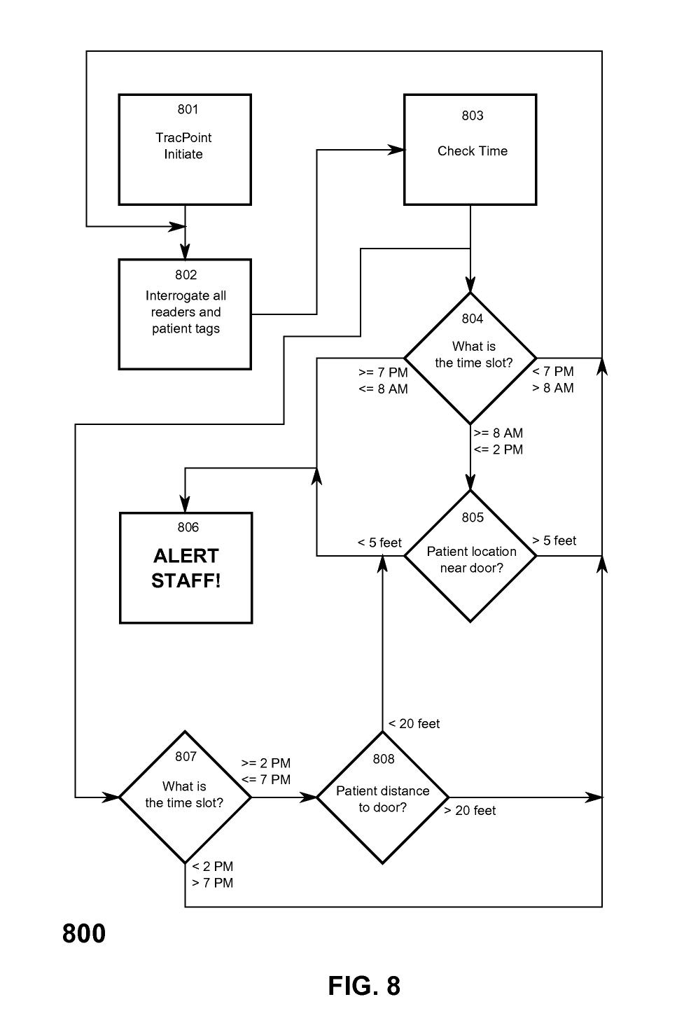

FIG. 8 Is a logic flowchart depicting logic sequence patient time slot and valid location tracking 800; firstly, start TracPoint™ 801 then go to interrogate all readers and patient tags 802 next go to check time 803 send time to first logic decision sequence point what is the time slot (?) 804 and second logic decision sequence point what is the time slot (?) 807; at first what is the time slot (?) decision sequence point 804; if time slot is greater then or equal to 7 PM and less than or equal to 8 AM go to ALERT STAFF! 806; if time slot is less than 7 PM and greater than 8 AM go back to interrogate all readers and patient tags 802; if time slot is less than or equal to 8 AM or greater than or equal to 2 PM go to logic decision sequence point patient location near exit door (?) 805; and if patient is greater than five feet go back to Interrogate all readers and patient tags 802; and if distance is less than five feet sound ALERT STAFF (?) 806. At second decision logic sequence what is the time slot (?) 807; if time is greater than 2 PM or less than 7 PM go to logic decision sequence point patient distance to door 808; if greater than twenty feet go back to interrogate all readers and patient tags 802; if patient distance is less than twenty feet go to sound ALERT STAFF! 806.

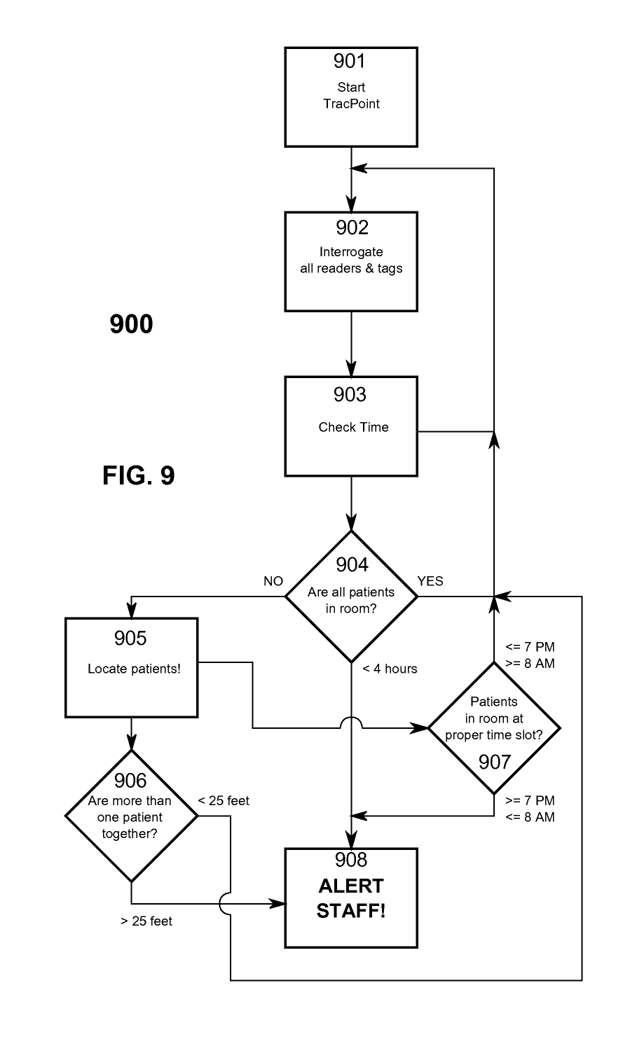

FIG. 9 is a logic flow chart 900 depicting conditions when patients are out of their designated rooms or too close to another patient. As said logic sequence follows through; TracPoint™ start 901 then go to interrogate all readers and tags 902; go to check time 903; logic decision sequence point are all patients in room (?) 904; if YES patients in room, go back to interrogate all readers and tags 902; if NO go to locate patients 905; if greater than four hours in room go to ALERT STAFF! 908; at logic decision sequence point locate patients 905 go to first decision sequence patients in room at proper time slot (?) 907; if greater than or equal to 7 PM and less than or equal to 8 AM go to back to interrogate all readers and tags 902; if less than or equal to 7 PM and greater than or equal to 8 AM go to ALERT STAFF! 908; at second logic decision are more than one patient together (?) 906, if greater than twenty five feet go back to interrogate all readers and tags 902; if less than twenty five feet go to ALERT STAFF! 908.

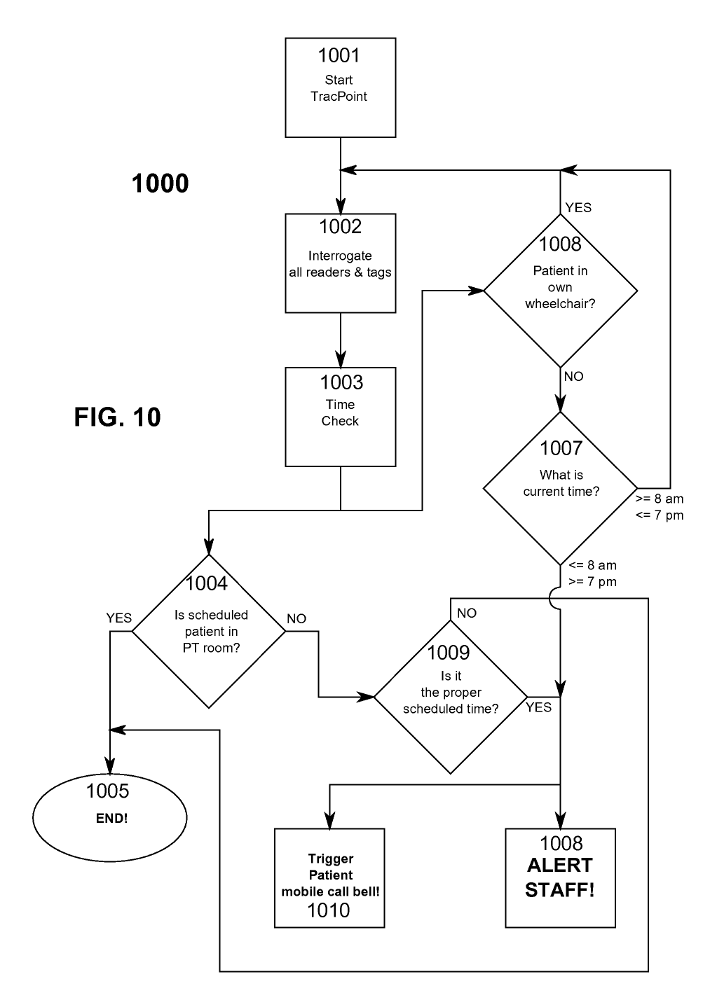

FIG. 10 is a logic flow chart depicting patient in wheel chair for scheduling physical therapy; start TracPoint™ 1001; interrogate all readers and tags 1002; go to time check 1003; go to first logic decision sequence point, is scheduled patient in PT room (?) 1004; if YES END! 1005; if NO go to second logic decision sequence point is it the proper scheduled time (?) 1009; if NO go to END! 1005; if YES go to ALERT STAFF! 1008; at time check 1003 go to third logic decision sequence point patient in own wheelchair (?) 1006; if YES go back to interrogate all readers and tags 1002; if NO go to fourth logic decision sequence point what is current time (?) 1007; if time is less than or equal to 8 AM and greater than or equal to 7 PM go back to interrogate all readers and tags 1002; if time is greater than 8 AM and less than 7 PM go to ALERT STAFF! 1008.

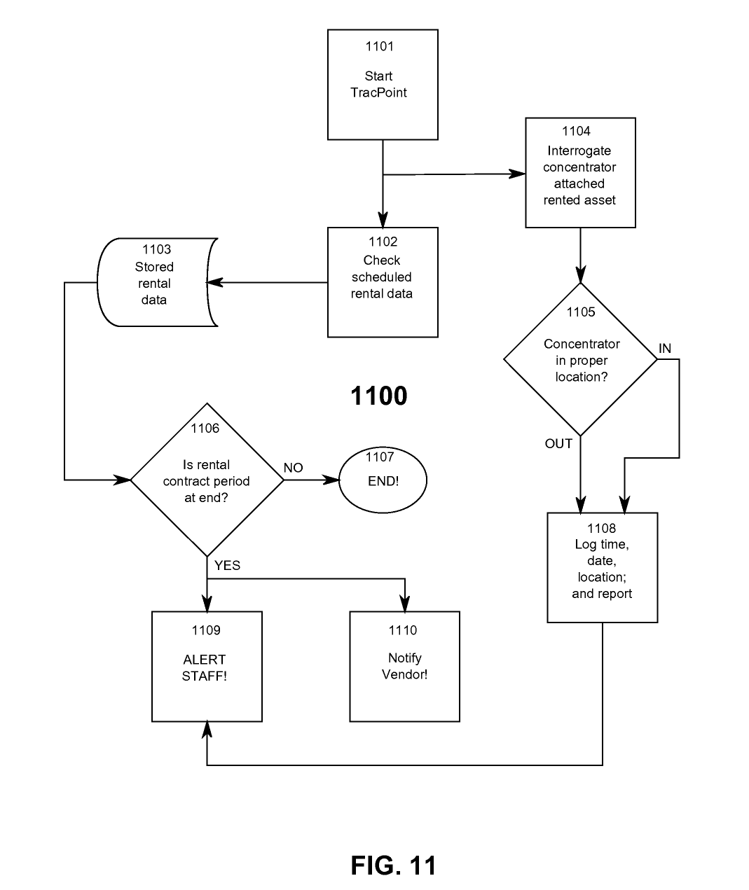

FIG. 11 is a logic flow chart depicting contract assets rental monitoring and validation to vendors; at start sequence TracPoint™ 1101 go to check scheduled rental data 1102; go to stored rental data 1103 memory storage for validation times and conditions; then go to first logic decision sequence point is rental contract period at end (?) 1106; if NO go to END! 1107; if YES go to ALERT STAFF! 1109 and Notify Vendor! 1110; from start TracPoint™ 1101 also go to interrogate concentrator (tag) attached to rented asset 1104; then go to second logic decision sequence point concentrator (tag) in proper location (?); if IN go to log time, date, location, and then report! 1108 and then go to ALERT STAFF! 1109; if OUT go to log time, date, location, and then report! 1108 and then go to ALERT STAFF! 1109.

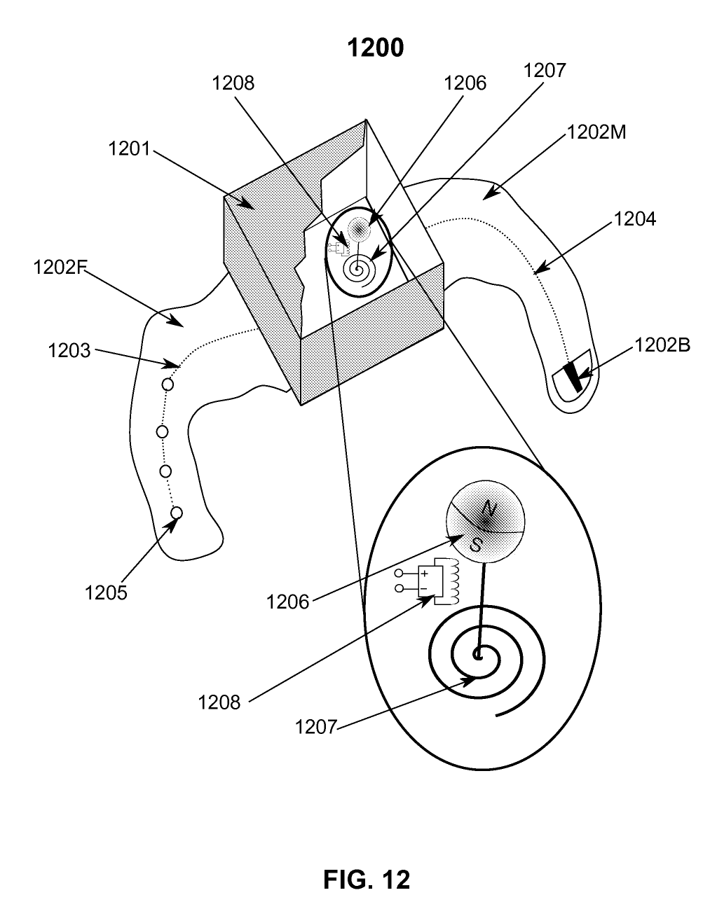

FIG. 12 is a perspective drawing of one embodiment of said wrist tag 1200 utilizing a patent pending or patented DEAK™ battery-less power source device method means, including a blow up section of said wrist tag embodiment 1201. Disposed and in communication with said tag 1201 is wrist band combination of a female strap side 1202F with a plurality of metal ring through holes 1205; disposed and in communication with said tag 1201 is a male strap side 1202M with disposed and attached metal buckle insert rod 1202B. Said plurality of metal ring through holes 1205 are in communication with an internal disposed thin wire 1203 that is disposed and in communication with the internal volume component of tag 1201 for connexion to transceiver circuitry (not shown). Said male strap side 1202M has disposed internal a thin wire 1204 that is in communication with attached metal buckle insert rod 1202B on male strap side 1202M and said thin wire 1204 in communication with the internal volume component of tag 1201 for connexion to transceiver circuitry (not shown). The purpose of said thin wires 1203 and 1204 are for completing a conductive circuit that will trigger, by being cut, an alarm logic state in said transceiver tag 1201. A battery-less power source comprised of a sphere magnet, but not limited to a sphere magnet means 1206 that is axially magnetized, in communication with a spring device means 1207 that is disposed and in communication with said tag embodiment 1201. Well within magnetic influencing proximity there exists disposed a coil wire and bridge rectifier device means 1208 that detects any slight movement of said sphere magnet 1206 and converts any vibrations or oscillations into useable induced and rectified electrical energy to sustain operation of said tag embodiment 1201 circuitry such as said transceiver (not shown) and GPS module (not shown).

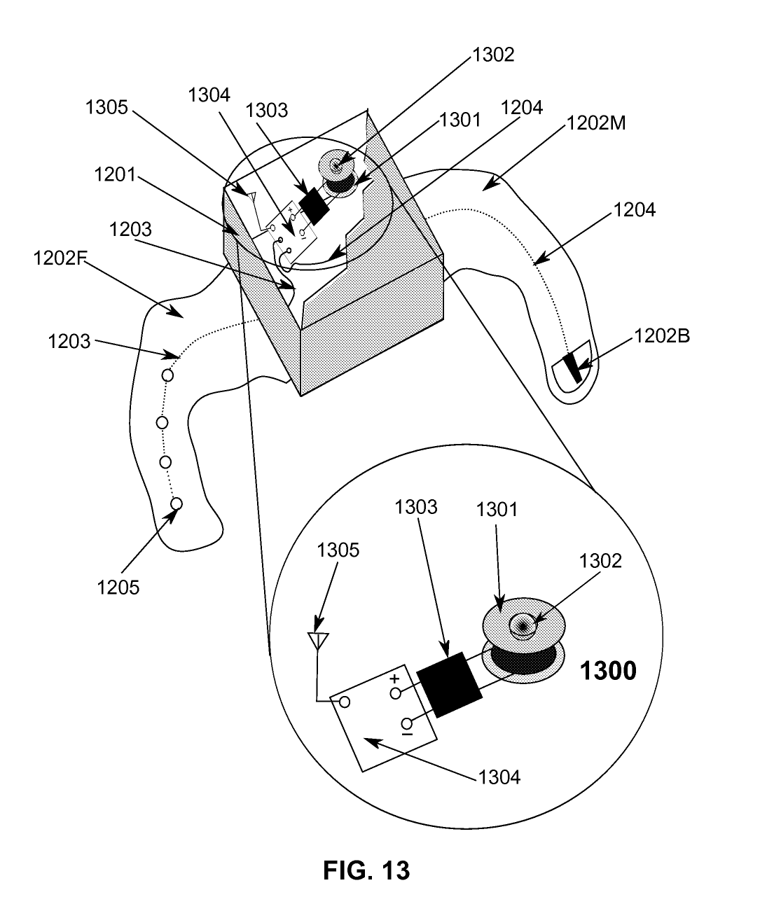

FIG. 13 is a perspective drawing of another embodiment of said wrist tag 1300 utilizing with a blow up section of said wrist tag embodiment 1201 utilizing a patent pending or patented DEAK™ battery-less power source device method means. Disposed and in communication with said tag 1201 is wrist band combination of a female strap side 1202F with a plurality of metal ring through holes 1205; disposed and in communication with said tag 1201 is a male strap side 1202M with disposed and attached metal buckle insert rod 1202B. Said plurality of metal ring through holes 1205 are in communication with an internal disposed thin wire 1203 that is disposed and in communication with the internal volume component of tag 1201 for connexion to transceiver circuitry (not shown). Said male strap side 1202M has disposed internal a thin wire 1204 that is in communication with attached metal buckle insert rod 1202B on male strap side 1202M and said thin wire 1204 in communication with the internal volume component of tag 1201 for connexion to transceiver circuitry 1304 that is comprised of an ISM Band transceiver and GPS module and a multi-band long range antenna 1305. The purpose of said thin wires 1203 and 1204 are for completing a conductive circuit that will trigger, by being cut, an alarm logic state in said transceiver tag 1201. Said transceiver module 1304 is powered and triggered with movement by a patent pending or patented DEAK™ battery-less and wireless transceiver method means comprised of a coil wire 1301 disposed with a centered axially magnetized sphere magnet, but not limited to a sphere magnet, said coil wire 1301 output is in communication with a disposed bridge rectifier 1303 that supplies DC power to said circuitry load 1304. Further said coil wire 1301 and its disposed axially magnetized sphere magnet 1302 produce electricity by any movement of said axially magnetized sphere magnet 1302.

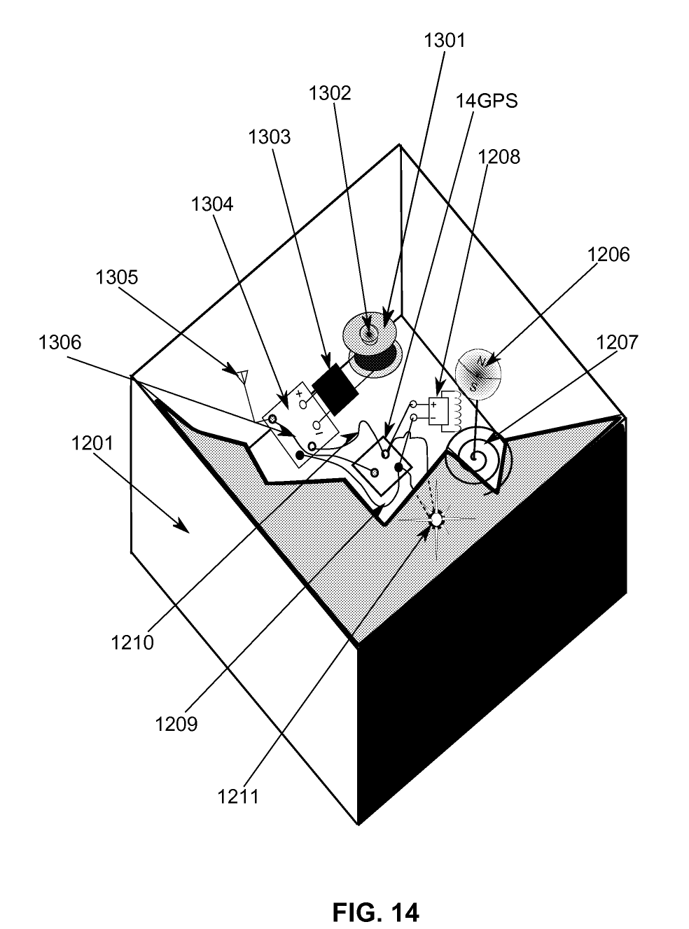

FIG. 14 is a perspective illustration of the internal component members of said wrist tag 1201. Included in said component members are; disposed said transceiver module 1304 is powered and triggered with movement by a patent pending or patented DEAK™ battery-less and wireless transceiver method means comprised of a coil wire 1301 disposed with a centered axially magnetized sphere magnet, but not limited to a sphere magnet, said coil wire 1301 output is in communication with a disposed bridge rectifier 1303 that supplies DC power to said circuitry load 1304. Further said coil wire 1301 and its disposed axially magnetized sphere magnet 1302 produce electricity by any movement of said axially magnetized sphere magnet 1302; a disposed patent pending or patented DEAK™ battery-less power source device method means, including a blow up section of said wrist tag embodiment 1201. Disposed and in communication with said tag 1201 is wrist band combination of a female strap side 1202F with a plurality of metal ring through holes 1205; disposed and in communication with said tag 1201 is a male strap side 1202M with disposed and attached metal buckle insert rod 1202B. Said plurality of metal ring through holes 1205 are in communication with an internal disposed thin wire 1203 that is disposed and in communication with the internal volume component of tag 1201 for connexion to transceiver circuitry 1304 Said male strap side 1202M has disposed internal a thin wire 1204 that is in communication with attached metal buckle insert rod 1202B on male strap side 1202M and said thin wire 1204 in communication with the internal volume component of tag 1201 for connexion to transceiver circuitry 1304 The purpose of said thin wires 1203 and 1204 are for completing a conductive circuit that will trigger, by being cut, an alarm logic state in said transceiver tag 1201; a patent pending or patented DEAK™ battery-less power source device method means comprised of a sphere magnet, but not limited to a sphere magnet means 1206 that is axially magnetized, in communication with a spring device means 1207 that is disposed and in communication with said tag embodiment 1201. Well within magnetic influencing proximity there exists disposed a coil wire and bridge rectifier device means 1208 that detects any slight movement of said sphere magnet 1206 and converts any vibrations or oscillations into useable induced and rectified electrical energy to sustain operation of said tag embodiment 1201 circuitry such as No said transceiver 1304 and GPS module 14GPS. Further disposed on surface of tag embodiment are; an LED indicator light 1211 to indicate when power is generated by said battery-less power source 1206, 1207, & 1208; and said coil wire 1302 and disposed and centered axially magnetized sphere magnet 1301 are disposed an in communication with said tag 1201 surface plane for external access to a consumer for triggering.

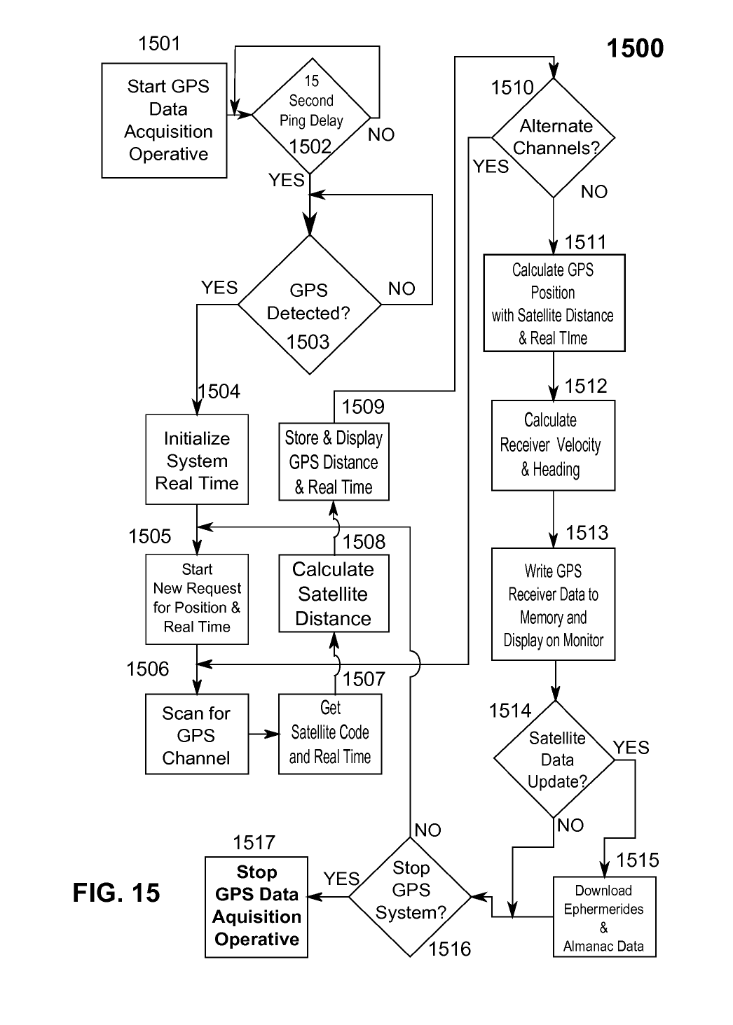

FIG. 15 is a logic flow chart for the operation of said GPS module 14 GPS in FIG. 14. TracPoint™ initiates interrogating GPS information for patient, staff, and assets location that will enable on-site administrative GPS location procedures, remote networked linked off-site administrative GPS location procedure and even mobile (cell) phone off or on site GPS location procedures to give maximum healthcare with safety and security for patients, staff, and assets. Firstly, a start GPS data acquisition operative 1501 is engaged and goes to first logic decision sequence point fifteen second ping delay (in place to conserve power consumption of GPS module) 1502; if NO where fifteen seconds is not counted loop back to start GPS 1501; if YES go to second logic decision sequence point GPS detected (?) 1503; if NO loop back; if YES go to initialize system real time 1504; go to start new request for position & real time 1505; ten go to scan for GPS channel 1506; get satellite code and real time 1507; then calculate satellite distance 1508; then store & display GPS distance and real time 1509; go to third logic decision sequence point alternate channels (?) 1510; if YES go back to scan for GPS channel 1506; if NO go to calculate GPS position with satellite distance & real time 1511; then go to calculate receiver velocity & heading 1512; then go to write GPS receiver data to memory & display on monitor 1513; go to third logic decision sequence point satellite data update 1514; if YES go to download Ephemerides & Almanac Data 1515 then go to fourth logic decision sequence point stop GPS system (?) 1516; if NO go back to start new request for position & real time 1505; if YES go to stop GPS data acquisition operative 1517; if at fourth logic decision sequence point result is NO then go to fourth logic decision sequence point stop GPS system (?) 1516; if NO go back to start new request for position & real time 1505; if YES go to stop GPS data acquisition operative 1517.

Note: For those steeped in the art, it should be obvious that Ephemerides and Almanac Data refer to the Geo Positioning Space Satellite Vehicles (GPSSV) that broadcast two types of data, Almanac and Ephemeris. Almanac data is course orbital parameters for all GPSSV s. Each GPSSV broadcasts Almanac data for ALL GPSSV s. This Almanac data is not very precise and is considered valid for up to several months. Ephemeris data by comparison is very precise orbital and clock correction for each GPSSV and is necessary for precise positioning. EACH GPSSV broadcasts ONLY its own Ephemeris data. This data is only considered valid for about 30 minutes. The Ephemeris data is broadcast by each GPSSV every 30 seconds.

When said GPS receiver module is initially turned on after being off for more than 30 minutes, it “looks” for GPSSV s based on where it is based on the Almanac and current time. With this information, appropriate GPSSV s can be selected for initial search.

The GPS receiver initially locks onto a GPSSV, said GPS receiver module displays on administrator computer. At this time, said Ephemeris data has yet to be completely collected. Once the ephemeris data is collected from EACH GPSSV in turn, the associated signal strength will be displayed on screen and then said data from that GPSSV is considered valid for patient, staff and assets position location validation.

If power is cycled on a GPS unit, and when turned back on, the Ephemeris data is less than 30 minutes old, lock-on will be very quick since the GPS does not have to collect new Ephemeris Data. This is called a “warm” start. If it is later than 30 minutes, this is considered a “cold” start and all Ephemeris Data will have to be recollected.

An embodiment is an implementation or example of said invention. References in the specification to “an embodiment,” “another embodiment,” “one embodiment,” “some embodiments,” or “other embodiments” means that a particular feature, structure, or characteristic described in connection with the embodiments is included in at least some embodiments, but not necessarily all embodiments of said present invention. The various appearances of “an embodiment,” “one embodiment,” or “some embodiments” are not necessarily all referring to the same embodiments.

If the specification states a component, feature, structure, or characteristic “may,” “might,” “can,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Said present invention is not restricted to the particular details described herein. Indeed, many other variations of the foregoing description and drawings may be made within the scope of said present invention. Accordingly, it is the following claims including any amendments thereto that define the scope of said present invention.

What is claimed is:

1. An interminable and non-compromising TracPoint™ rules engine based hospital or healthcare congregate facility patient, staff, and assets location, monitoring, safety and security on-site or remote off-site administrative and caregiver monitoring and battery-less and wireless RFID transmission system means and GPS receiver means comprising;
at least one on-site computer system means with high speed internet access means or a plurality of computer means, each with high speed internet access means;
at least one RF wireless transceiver concentrator relay interface means in communication with said on-site computer, or a plurality of RF wireless transceiver concentrator relay interface means all in communication with said On-site computer; and
whereby said RF wireless concentrator relay interface means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility; and
at least one RF wireless transceiver reader means, or a plurality of RF wireless transceiver reader means that are in communication with said on-site computer through said RF wireless transceiver concentrator relay interface means, or plurality of RF wireless transceiver concentrator relay interface means and in communication with each other reader means or plurality of RF wireless transceiver reader means; and
whereby said RF wireless reader means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility; and
at least one wearable non-compromising hospital or healthcare congregate facility resident-patient identification patent pending or patented DEAK™ battery-less RF wireless transceiver tag means, or a plurality of wearable non-compromising hospital or healthcare congregate facility resident-patient identification patent pending or patented DEAK™ battery-less RF wireless transceiver tag means that are in communication with said computer through said patent pending or patented DEAK™ battery-less RF wireless transceiver reader means, or a plurality of patent pending or patented DEAK™ battery-less RF wireless transceiver reader means and said patent pending or patented DEAK™ battery-less RF wireless transceiver concentrator relay interface means, or plurality of patent pending or patented DEAK™ battery-less RF wireless transceiver concentrator relay means; and
whereby said wearable non-compromising hospital or healthcare congregate facility resident-patient identification patent pending or patented DEAK™ battery-less RF wireless transceiver tag means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility; and
a custom software rules engine based program that controls all action and interaction with said on-site or remote off-site computer system with high speed internet access, or a plurality of on-site or remote off-site computers, each with high speed internet access; and
a patent pending or patented DEAK™ battery-less RF wireless concentrator interface means, or plurality of patent pending or patented DEAK™ battery-less RF wireless concentrator interface means and all said patent pending or patented DEAK™ battery-less RF wireless transceiver means comprising;
an RF wireless reader or a plurality of RF wireless transceiver readers; and
whereby said RF wireless transceiver reader means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility; and
a wearable non-compromising patent pending or patented DEAK™ battery-less RF wireless transceiver hospital or healthcare congregate facility resident-patient identification tag means or a plurality of wearable non-compromising patent pending or patented DEAK™ battery-less RF wireless transceiver hospital or healthcare congregate facility resident-patient identification tag means; and
whereby said wearable non-compromising home or congregate facility resident-patient identification patent pending or patented DEAK™ battery-less RF wireless transceiver tag means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility; and
all of which are in communication with said hospital or healthcare congregate facility resident-patient and continuously monitoring all of said hospital or healthcare congregate facility resident-patient, or a plurality of home or congregate facility resident-patients movement caregiver staff, and assets in an omni-directional volume space either internal to a preferred designated perimeter environment or external to a preferred designated perimeter environment; and
all of which are patent pending or patented DEAK™ battery-less RF wirelessly in communication with a GPS for coordinates recognition and reporting; and
a wearable non-compromising patent pending or patented DEAK™ battery-less RF wireless transceiver on site caregiver identification tag means or a plurality of wearable non-compromising patent pending or patented DEAK™ battery-less RF wireless transceiver on site caregiver identification tag means; and
whereby said wearable non-compromising patent pending or patented DEAK™ battery-less RF wireless transceiver on-site caregiver identification tag means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility;
all of which are in communication with said on-site caregiver and continuously monitoring all of said on-site caregiver, or a plurality of on-site caregivers movement in an omni-directional volume space either internal to a preferred designated perimeter environment or external to a preferred designated perimeter environment;
all of which are patent pending or patented DEAK™ battery-less RF wirelessly in communication with a GPS for coordinates recognition and reporting.

2. The non-compromising home or congregate facility resident-patient location, on site caregiver monitoring and transmission system means as recited in claim 1,
wherein an interminable logical and systemic procedure rules engine methodology for a non-compromising hospital or healthcare congregate facility resident-patient location, on site caregiver monitoring and transmission system comprising;
a custom proprietary rules engine based software-firmware embodiment;
a GPS transceiver embedded in each patient wristband tag means for instant location and means of monitoring and announcing said instant location;
a GPS transceiver embedded in each caregiver RF wireless transceiver tag means for instant location and means of monitoring and announcing said instant location.

3. The non-compromising home or congregate facility resident-patient location, on site caregiver monitoring and transmission system means as recited in claim 1, wherein an attached and secured adjustable wrist or ankle band that is applied around the entire circumference of a limb such as a wrist or ankle comprising;
an adjustable fastening means; and
an embedded wire means that runs all throughout said adjustable band in a methodology means of surrounding the inner perimeter of said band so as to provide a closed loop in cooperation with a circuitous path for electrical current to pass; and
is connected to an attached patent pending or patented DEAK™ battery-less RF wireless transceiver tag means with a microcontroller embodiment means with at least one input and output port or a plurality of input and output ports for the purpose of providing;
an interminable and non-compromising logic state, where said logic state is changed by action of said embedded wire is connected to a digital input/output pin of said microcontroller; and
said microcontroller applies a logic level to one side of said embedded wire and verifies that it appears on the other side of said embedded wire; and
said electrical configuration is such that there is no current flowing through said embedded wire when said microcontroller is asleep; and
this action is established to conserve battery life; and
If said embedded wire is cut or broken for any reason by said patient or any other personage or accidental situation then;
said microcontroller turns on tag of patient wristband patent pending or patented DEAK™ battery-less RF wireless transceiver to transmit; an alert signal throughout said designated field strength mesh zones defined; internal (indoors) and external (outdoors); and
a procedure of communicating with said family portal; and
said family portal being in instant communications with said remote administration portal via high speed internet access; and
said administration making a decision to alert said designated remote guardian caregiver or a plurality of said designated remote guardian caregivers.

4. The non-compromising hospital or healthcare congregate facility resident-patient location, on site caregiver monitoring and transmission system means as recited in claim 1, wherein said patent pending or patented DEAK™ battery-less RF wireless transceiver reader means is electrically connected to said magnetic proximity door switch means; and
is held in a logic state of true when any said designated door is closed and defined as safe and internal perimeter closed; and
said closed logic condition is maintained by the proximity of a permanent magnetic field means.

5. The non-compromising hospital or healthcare congregate facility resident-patient location, on site caregiver monitoring and transmission system means as recited in claim 1, wherein there is established a interminable and non-compromising RF mesh zone network throughout said designated internal volume of patient area; and
there is established a interminable and non-compromising RF mesh zone network throughout said designated external facility courtyard or recreational volume of patient area;
there is established an interminable and non-compromising RF mesh zone network throughout said designated external facility-grounds volume of patient area.

6. The non-compromising hospital or healthcare congregate facility resident-patient location, on-site caregiver monitoring and transmission system means as recited in claim 1, wherein there is established a interminable and non-compromising RF mesh zone network throughout said designated volume that is external and remote to said designated internal volume of patient area or designated facility-grounds area.

7. The non-compromising hospital or healthcare congregate facility resident-patient location, on-site caregiver monitoring and transmission system means as recited in claim 1, wherein a methodology of utilizing a commonality and universality of circuitry for said reader device means or plurality of readers and said concentrator relay device means or plurality of concentrator relay device means for optimum cost effective of said recited system of claim 1.

8. The non-compromising hospital or healthcare congregate facility resident-patient location, on site caregiver monitoring and transmission system means as recited in claim 1, wherein a methodology of utilizing a commonality and universality of circuitry for said caregiver patent pending or patented DEAK™ battery-less RF wireless tag means or plurality of said caregiver patent pending or patented DEAK™ battery-less RF wireless tag means and said patient patent pending or patented DEAK™ battery-less RF wireless wristband tag means or plurality of said patient patent pending or patented DEAK™ battery-less RF wireless wristband tag means for optimum cost effective of said recited system of claim 1.

9. The non-compromising hospital or healthcare congregate facility resident-patient location, on-site caregiver monitoring and transmission system means as recited in claim 1, whereby designated caregiver entry and exit voucher information; and caregiver location information is recorded and stored in said TracPoint™ rules engine based memory high speed internet access computer portal means and said remote administrative rules engine based high speed internet access computer portal means.

10. The non-compromising hospital or healthcare congregate facility resident-patient location, on site caregiver monitoring and transmission system means as recited in claim 1, whereby designated remote caregiver or plurality of designated remote caregivers location information and mobile or home phone information is recorded and stored in said TracPoint™ rules engine based high speed internet access computer portal means and said remote TracPoint™ rules engine based administrative high speed internet access computer portal means; and said information is alerted by said TracPoint™ rules engine based high speed internet access portal means and remote administrative high speed internet access computer portal means.

11. The non-compromising hospital or healthcare congregate facility resident-patient location, on-site caregiver monitoring and transmission system means as recited in claim 1, whereby it is established a commonality and universality of all system circuitry to be hardware identical;
and software changeable;
and firmware changeable;
in accord to any and all requirements to make optimum;
said present invention as recited in claim 1;
and to optimize system's requirements for any and all environs designated as a utility candidate for said present invention.

12. The non-compromising hospital or healthcare congregate facility resident-patient location, on-site caregiver monitoring and transmission system means as recited in claim 1, whereby an action of all TracPoint™ rules engine based recorded and stored history means of all patient or all plurality of patients activity;
and further action of all caregiver or plurality of caregivers TracPoint™ rules engine based recorded and stored history means of all caregiver activity related to on site functionality;
and further action of all remote caregiver or plurality of remote caregivers recorded and stored TracPoint™ rules engine based history of all activity related to remote caregiving functionality; and
all TracPoint™ rules engine based recorded and stored information be on file with said TracPoint™ rules engine based high speed internet access computer portal means and said TracPoint™ rules engine based remote administrative high speed internet access computer portal means.

13. The non-compromising hospital or healthcare congregate facility resident-patient location, on-site caregiver monitoring and transmission system means as recited in claim 1, wherein a backhaul methodology means is employed and utilized by TracPoint™ rules engine to evaluate, maintain, and perform any decision making for purposes of providing non-compromising hospital or healthcare congregate facility resident-patient safety, security, and care receiving from designated caregivers, designated remote caregivers, designated TracPoint™ rules engine based computer portal operatives that have high speed internet access, and designated TracPoint™ rules engine based remote administrative computer portal operatives that have high speed internet access; and
whereby said backhaul methodology means is executed securely and stored in said designated TracPoint™ rules engine based portal, and designated remote administrative portal.

14. The non-compromising hospital or healthcare congregate facility resident-patient location, on-site caregiver monitoring and transmission system means as recited in claim 1, whereby said patent pending or patented DEAK™ battery-less RF wireless transceiver sensor or transducer means;
is sensor functional and driven or transducer functional and driven; and
whereby said designated and described sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility.
at least one patent pending or patented DEAK™ battery-less RF wireless transceiver means, or a plurality of patent pending or patented DEAK™ battery-less RF wireless transceiver means that are in communication with said computer through said patent pending or patented DEAK™ battery-less RF wireless transceiver concentrator relay interface means, or plurality of patent pending or patented DEAK™ battery-less RF wireless transceiver concentrator relay interface means and in communication with each other patent pending or patented DEAK™ battery-less RF wireless transceiver reader means or plurality of RF wireless transceiver reader means; and
whereby said patent pending or patented DEAK™ battery-less RF wireless reader means is sensor or transducer driven; and
whereby said sensor or transducer is of generic or specific type to convert RF energy into digital or analogue electrical energy, for any purpose and utility; or
whereby said sensor or transducer is of generic or specific type to convert mechanical vibration, motion, and any changes in motion energy into digital or analogue electrical energy, for any purpose and utility; or
whereby said sensor or transducer is of generic or specific type to convert thermal energy into digital or analogue electrical energy, for any purpose and utility; or
whereby said sensor or transducer is of generic or specific type to convert chemical energy into digital or analogue electrical energy, for any purpose and utility; or
whereby said sensor or transducer is of generic or specific type to convert light energy into digital or analogue electrical energy, for any purpose and utility; or
whereby said sensor or transducer is of generic or specific type to convert electrical capacitance into digital or analogue electrical energy, for any purpose and utility; or
whereby said sensor or transducer is of generic or specific type to convert electrical inductive coupling energy into digital or analogue electrical energy, for any purpose and utility; or
whereby said sensor or transducer is of generic or specific type to convert human vital sign energy into digital or analogue electrical energy, for any purpose and utility; or
whereby said sensor or transducer is of generic or specific type to convert animal vital sign energy into digital or analogue electrical energy, for any purpose and utility; or
whereby said sensor or transducer is of generic or specific type to convert inanimate object information energy into digital or analogue electrical energy, for any purpose and utility.

15. The non-compromising hospital or healthcare congregate facility resident-patient location, on-site caregiver monitoring and transmission system means as recited in claim 1, wherein said patient worn RF wireless transceiver tags are powered and triggered by said patent pending or patented DEAK™ battery-less power source device means.

16. The non-compromising hospital or healthcare congregate facility resident-patient location, on-site caregiver monitoring and transmission system means as recited in claim 1, wherein said caregiver staff worn RF wireless transceiver tags are powered and triggered by said patent pending or patented DEAK™ battery-less power source device means.

17. The non-compromising hospital or healthcare congregate facility resident-patient location, on-site caregiver monitoring and transmission system means as recited in claim 1, wherein said assets supplied RF wireless transceiver tags are powered and triggered by said patent pending or patented DEAK™ battery-less power source device means.
